(19) United States
(12) Patent Application Publication
(10) Pub. No.: US 2010/0200015 A1
(43) Pub. Date: Aug. 12, 2010

(54) COMBINATION TOOTHPICK AND FLOSSER FOR DENTAL CARE

(75) Inventor: Louis Sharoff, Bloomingburg, NY (US)

Correspondence Address: THOMPSON HINE L.L.P.;Intellectual Property Group, P.O. BOX 8801, DAYTON, OH, 45401-8801, US

(73) Assignee: Majestic Drug Company, Inc., South Fallsburg, NY (US)

(21) Appl. No.: 12/369,869

(22) Filed: Feb. 12, 2009

(51) Int. Cl. A61C 15/04

(52) U.S. Cl. 132/323

(57) ABSTRACT

Apparatus for cleaning the teeth comprising a flosser portion and an elongated member which extends from the flosser portion is described. A pick which also extends from the elongated member and may be at a variety of angles with respect to the elongated portion.

### TECHNICAL FIELD

The invention relates to apparatus and methods for flossing teeth and the removing of dental debris.

### CROSS REFERENCE TO RELATED APPLICATIONS

Not applicable.

### STATEMENT REGARDING FEDERALLY SPONSORED RESEARCH OR DEVELOPMENT

Not applicable

### BACKGROUND OF THE INVENTION

Today, there are wide variety of products on the market for dental care. These include brushes, plaque washes, and flossing devices, as well as traditional products such as toothpaste, spools of floss, mouth wash, and so forth.

### SUMMARY OF THE INVENTION

In accordance with the invention, a device is provided for effectively flossing and removing interdental debris from the teeth, particularly debris deposited on or most accessible from the lingual side of interdental gaps.

The device is comprised of a flosser portion with an elongated member extending from a flosser portion. A pick extends from the elongated member. The pick is inserted between two adjacent teeth and the point of the pick is moved up and down between the teeth in order to remove the accumulated debris.

The inventive apparatus may further comprise a pick which is on an angle to the elongated member. This inventive device has the advantage of being manufactured with different angles thus meeting the preference of different users.

The pick angle can be between 15 and 36° and is roughly perpendicular to the vertical elongated member. The pick lies in a plane defined by the flosser member and the elongated member.

The flosser may be of a stirrup configuration. Alternatively it may be substantially U-shaped and the bottom of the U-shape roughly aligns with the elongated member.

### BRIEF DESCRIPTION THE DRAWINGS

The operation of the invention will become apparent from the following description taken in conjunction with the drawings, in which:

FIG. 1 illustrates a plan view of the inventive interdental hygienic device;

FIG. 2 is a side view of the interdental hygienic device illustrated in FIG. 1 along lines 2-2 of FIG. 1;

FIG. 3 is a view of the interdental hygienic device illustrated in FIG. 1 along lines 3-3 of FIG. 1;

FIG. 4 illustrates an alternative embodiment of the inventive interdental hygienic device;

FIG. 5 is a plan view of embodiment of FIG. 4;

FIG. 6 illustrates the use of the embodiment in FIG. 4, where the device is inserted into the mouth between the upper and lower jaws, inserted between two teeth in order to remove accumulated debris.

FIG. 7 illustrates that the angle of the embodiment in FIG. 4 makes it well-suited to deal with debris on both sides of the mouth;

FIG. 8 is a plan view of yet another alternative embodiment;

FIG. 9 illustrates the embodiment of FIG. 8 as used in a fashion similar to that employed in the use of embodiments of FIG. 1 and FIG. 4.

FIG. 10 is a plan view of yet another alternative embodiment of the invention;

FIG. 11 is a plan view of yet another alternative embodiment of the invention;

FIG. 12 illustrates a perspective view of yet another alternative embodiment of the invention;

FIG. 13 is a plan view of yet another alternative embodiment of the invention; and

FIG. 14 is a plan view of yet another alternative embodiment of the invention;

### DETAILED DESCRIPTION OF THE PREFERRED EMBODIMENTS

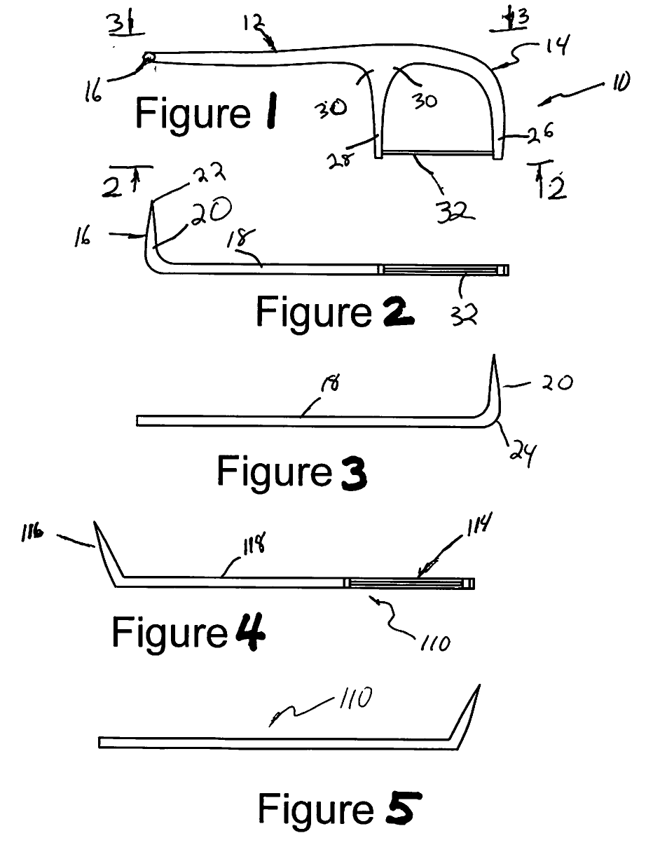

Referring to FIG. 1, the inventive interdental hygienic device 10 is illustrated in plan view. Device 10 comprises a handle portion 12, a flosser portion 14, and a pick portion 16. Pick portion 16 may be seen most clearly in FIG. 2, which is a view of the device 10 illustrated in FIG. 1 along lines 2-2 of FIG. 1.

Handle portion 12 comprises a simple elongated member 18 extending between flosser portion 14 and pick portion 16. Pick 20 is a simple elongated member Point 22 is small enough to enter into the gap between adjacent teeth in the manner of a conventional toothpick. Pick 20 extends at a substantially right angle with respect to the plane defined by handle portion 12 and flosser portion 14.

Referring to FIG. 3, which is a view along lines 3-3 of FIG. 1, pick 20 is joined to elongated member 18 at joint portion 24, which may be reinforced for added strength if desired.

Flosser portion 14 comprises an outer support arm 26 and an inner support arm 28. Inner support arm 28 is, optionally, more securely mounted by reinforcement portions 30 at its juncture with elongated member 18.

As can be seen in FIG. 1 and FIG. 2, a length of floss 32 extends between outer support arm 26 and inner support arm 28.

Referring to FIGS. 4 and 5, an alternative embodiment of the inventive device 110 is illustrated. Device 110 includes a flosser portion 114, and a pick portion 116. The embodiment of FIG. 4 differs from the embodiment of FIG. 1 insofar as pick portion 116 is oriented at an angle of 22½° with respect to a vertical to elongated member 118. In other words, pick 120 extends at an angle of approximately 77½° with respect to the plane defined by flosser portion 114.

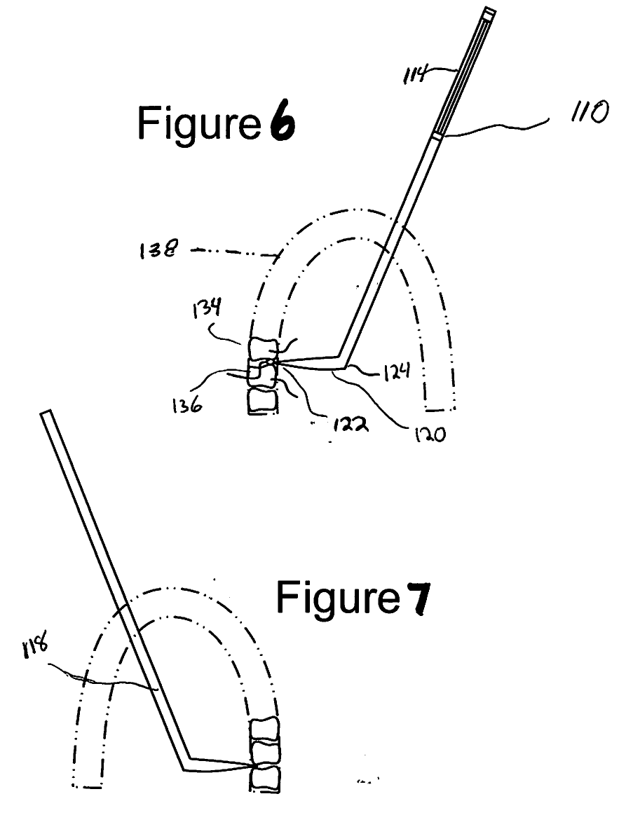

Referring to FIG. 6, the use of the inventive device 110 is illustrated. Generally, device 110 is inserted into the mouth between the upper and lower jaws, and the point 122 is inserted between two adjacent teeth 134 and 136 in jaw 138. The user holds device 110 and moves the point 122 up and down between the teeth 134 and 136 to remove accumulated debris. The inventive device has the advantage of being manufactured with the desired angle between the elongated portion 118. Accordingly, it is possible to build in any desired degree of strength into joint portion 124.

It is noted that the orientation of flosser portion 114 is such that when held in the hand, it allows the application of force to the pick 120.

Referring back to FIGS. 1-3, it is noted that the right angle that pick 20 makes with elongated member 18 enables device 10 to be used in a manner similar to that in which the device of FIGS. 4 and 5 are used, except that the inventive device 10, instead of being obliquely positioned with respect to the axis of symmetry of the jaw, will be more parallel to the axis of the jaw in the case of teeth in the rear of the mouth.

In the case of teeth which are not at the rear of the mouth but more toward the front, the position of the toothpick will be increasingly oblique, in order to achieve a right angle between a tangent to the jaw line and the pick portion. In this respect, it is believed that the embodiment of FIG. 1 will be more acceptable to most users, although some users will have a preference for the embodiment of FIG. 4 or 5.

Referring back to FIGS. 6 and 7, and in particular FIG. 7, it is seen that the angle of the pick makes it well-suited to deal with debris on both sides of the mouth.

Turning to FIG. 8, still yet another embodiment of the invention is illustrated. In this case, the inventive device 210 includes a pick 220 which is oriented at an angle substantially contained within the plane defined by flosser portion 214. It is noted that this angle is at approximately 22.5° to the normal to the elongated support member 218.

Referring to FIG. 9, the use of the device 210 of FIG. 8 is illustrated in connection with the cleaning of debris accumulated in the gap between a pair of teeth 234 and 236 in jaw 238.

The device 210 illustrated in FIG. 8 is used in a fashion similar to that employed in the use of the embodiments of FIGS. 1 and 4. However, the construction of this device is particularly advantageous to the application of force in the up-and-down direction to dislodge debris which has been caught in the interdental gap between the teeth. It is noted that certain users may find the design of FIG. 1-3, 4-5 or 8 preferable, due to the configuration of their teeth or the nature of the debris which periodically is caught in the gaps between their teeth. Factors may involve eating habits, interdental gap configuration and so forth.

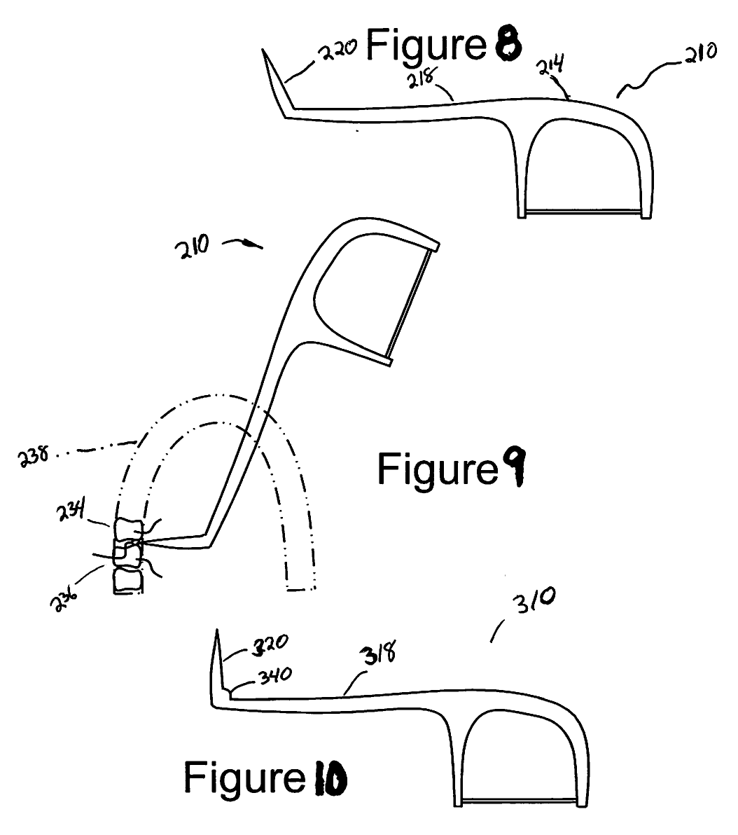

Referring to FIG. 10, yet another embodiment of the inventive device 310 is illustrated. Device 310 is substantially identical to the device illustrated in FIG. 8, except that pick portion 320 extends at a right angle to elongated handle 318. This embodiment also optionally includes a reinforced portion 340 which strengthens the joint between pick portion 320 and elongated handle portion 318.

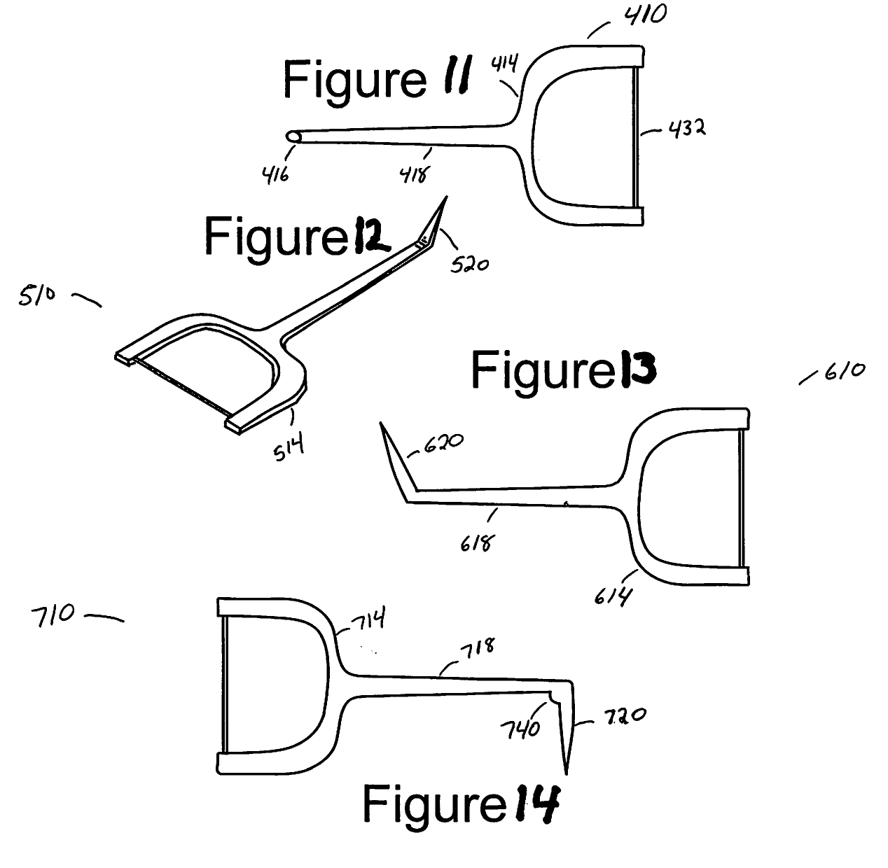

Referring to FIG. 11, yet another alternative embodiment of the inventive device 410 is illustrated. In the embodiment illustrated in FIG. 11, a flosser portion 414 takes a conventional stirrup shaped and supports a length of floss 432. Pick 420 extends at a right angle to elongated portion 418.

Referring to FIG. 12, yet another alternative embodiment of the present device 510 substantially similar to that illustrated in FIG. 12, is illustrated. The only difference is the orientation of pick 520 is at an oblique angle.

Referring to FIG. 13, yet another alternative embodiment of the inventive device 610 in which an obliquely oriented pick 620 is contained within the plane defined by elongated 618 and flosser portion 614.

Referring to FIG. 14, another alternative of the present device 710 is substantially identical to that shown in FIG. 13, except that pick 720 is oriented at a substantially right angle to elongated member 718, and the joint between pick 720 and elongated member 718 is reinforced with additional material 740.

What is claimed:

1. Apparatus for cleaning the teeth, comprising:
(a) a flosser portion;
(b) and elongated member extending from said flosser portion; and
(c) a pick extending from said elongated member, said pick could be on an angle with respect to said elongated portion;

2. Apparatus as in claim 1, wherein the said angle is roughly about 22½° with respect to the vertical elongated member.

3. Apparatus as in claim 1, wherein said angle is roughly perpendicular with respect to the vertical elongated member.

4. Apparatus as in claim 1, wherein said angle is between 15 and 36°.

5. Apparatus as in claim 1, wherein said pick roughly lies in a plane defined by set flosser member.

6. Apparatus as in claim 1, wherein said pick roughly lies in a plane defined by said flosser member and said elongated member.

7. Apparatus as in claim 1, wherein said flosser member is of a stirrup configuration.

8. Apparatus as in claim 1, wherein said flosser member is substantially U-shaped and the bottom of said U-shape roughly aligns with said elongated member.
